(19) United States
(12) Patent Application Publication
(10) Pub. No.: US 2009/0201220 A1
(43) Pub. Date: Aug. 13, 2009

(54) HIGH IMPEDANCE SURFACE STRUCTURE USING ARTIFICIAL MAGNETIC CONDUCTOR, AND ANTENNA AND ELECTROMAGNETIC DEVICE USING THE SAME STRUCTURE

(76) Inventors: Dong-Ho Kim, Daejeon-city (KR); Jae-Ick Choi, Daejeon-city (KR); Dong-Uk Sim, Chungcheongbuk-do (KR); Jong-Hwa Kwon, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 12/295,910

(22) PCT Filed: Dec. 4, 2006
(86) PCT No.: PCT/KR06/05184

§ 371 Date: Oct. 3, 2008

(30) Foreign Application Priority Data
Apr. 4, 2006 (KR) 10-2006-0030510

(51) Int. Cl. H01Q 1/00; H01Q 1/38

(52) U.S. Cl. 343/907; 343/700 MS

(57) ABSTRACT

Provided are a high impedance surface structure using an AMC (artificial magnetic conductor) and an antenna and an electromagnetic device using the high impedance surface structure. The high impedance surface structure includes: a ground layer formed of a first conductor layer; a first dielectric layer formed on the ground layer; and an HIS (high impedance surface) layer formed of second conductor layers and a second dielectric layer on the first dielectric layer, wherein the second conductor layers are interdigitated with one another and vias connecting the second conductor layers to the ground layer are not formed.

### TECHNICAL FIELD

The present invention relates to a high impedance surface structure used in an electromagnetic device, and more particularly, to a high impedance surface structure using an artificial magnetic conductor (AMC).

### BACKGROUND ART

Magnetic conductors correspond to generally used electrical conductors. Tangent components of electric fields are almost ‘0’ on surfaces of the electrical conductors while tangent components of magnetic fields are almost ‘0’ on surfaces of the magnetic conductors. Thus, a magnetic flux cannot flow on the surfaces of the electrical conductors while a current cannot flow on the surfaces of the magnetic surfaces.

The magnetic conductors operate as open circuits having considerably high resistances in specific frequencies due to the characteristics of the magnetic conductors. To manufacture such a magnetic conductor, an existing electrical conductor such as copper, silver, or gold is constituted in a specific geometric shape so as to have the characteristics of the magnetic conductor. Thus, the magnetic conductor manufactured in such a way is called an artificial magnetic conductor (AMC).

A high impedance surface structure is realized using such an AMC. In a high impedance surface structure using a conventional AMC, an upper conductor layer having a specific pattern is connected to a ground surface through a via.

FIG. 1 is a perspective view of a high impedance surface structure manufactured using a conventional AMC. Referring to FIG. 1, the high impedance surface structure includes a lower ground layer 20, a first dielectric layer 10, a second dielectric layer 30, conductor layers 40 constituting an upper high impedance surface (HIS) layer, and contact vias 50 connecting the conductor layers 40 to the lower ground layer 20.

The lower ground layer 20 is formed of a conductor, and the conductor layers 40 are formed in a predetermined pattern, for example, a rectangular pattern, so that the second dielectric layer 30 is formed in the conductor layers 40. A capacitive frequency selective surface (CFSS) is formed on capacitor patterns of the second dielectric layer 30 and the conductor layers 40. Also, the conductor layers 40 are connected to the lower ground layer 20 through the contact vias 50 so as to realize a high impedance surface structure due to a resonance phenomenon.

However, such a conventional high impedance surface structure including vias is manufactured in a complicated process and incurs high manufacturing costs. In addition, the whole thickness of the conventional AMC increases. The conventional high impedance surface structure is applicable only to a limited number of fields due to the limitations mentioned above.

As such, when a conventional antenna is placed on an electrical conductor, the efficiency of the conventional antenna deteriorates or a resonance frequency of the conventional antenna is distorted in the vicinity of a high dielectric medium or a high loss medium.

### DISCLOSURE OF INVENTION

### Technical Problem

The present invention provides a relatively thin high impedance surface structure manufactured in a simple process at a low cost using an artificial magnetic conductor AMC, and an electromagnetic device using the high impedance surface structure.

### Technical Solution

The present invention also provides an antenna using a high impedance surface structure so as to prevent efficiency of the antenna from decreasing, a resonance frequency of the antenna from distorting and to realize multi-band characteristics.

According to an aspect of the present invention, there is provided a high impedance surface structure using AMC (an artificial magnetic conductor), including: a ground layer formed of a first conductor layer; a first dielectric layer formed on the ground layer; and an HIS (high impedance surface) layer formed of second conductor layers and a second dielectric layer on the first dielectric layer, wherein the second conductor layers are interdigitated with one another, so that the second dielectric layer is positioned between the second conductor layers, and vias connecting the second conductor layers to the ground layer are not formed.

According to another aspect of the present invention, there is provided a high impedance surface structure using an AMC, including: a ground layer formed of a first conductor layer; a first dielectric layer formed on the ground layer; and an HIS layer formed of second conductor layers and a second dielectric layer on the first dielectric layer. The second conductor layers may be interdigitated with one another so that the second dielectric layer is positioned between the second conductor layers. The HIS layer may include unit cells having square horizontal cross-sections and identical patterns in which four strands of the second dielectric layers are connected to one another in the form of a Chinese character [symbol] or ‘ [symbol] ’ positioned ¼ the distance from each vertex along a diagonal line. Two Chinese characters [symbol] may be formed within a first diagonal line from each vertex of each of the unit cells, and two Chinese characters ‘ [symbol] ’ may be formed within a second diagonal line from each vertex of each of the unit cells. Components of the second dielectric layers may spread vertically and horizontally in the form of beat waves at connection points of the Chinese characters [symbol] or ‘ [symbol] ’, and the beat waves may have a largest amplitude on four sides of the square and complete one cycle at the connection points of the Chinese characters [symbol] or ‘ [symbol] ’. Patterns of the components of the second dielectric layers may be formed in the dot symmetric form based on the connection points. The components of the second dielectric layer having a width less than a predetermined length may be bent at a right angle so that the beat waves include at least three crests or troughs for one cycle between the connection points. Via s may be formed between the second conductor layers and the ground layer to realize a characteristic of the AMC.

According to another aspect of the present invention, there is provided an antenna device using a high impedance surface structure, including: the high impedance surface structure of claim 1; and an antenna adhered on an upper surface of the high impedance surface structure.

According to another aspect of the present invention, there is provided an electromagnetic device manufactured using the high impedance surface structure.

### ADVANTAGEOUS EFFECTS

As described above, the high impedance surface structure using an AMC according to the present invention does not require vias between conductor layers of a high impedance surface structure and a ground layer. Thus, a process of manufacturing the vias can be omitted, and manufacturing costs due to the vias can be reduced.

Also, utilization efficiency of a space for conductors of the high impedance surface structure can be increased, and a frequency band can be accurately and easily tuned since the high impedance surface structure is fully utilized.

Furthermore, the conductors of each unit cell can be interdigitated. Thus, an area of each unit cell required for obtaining a high impedance characteristic for a specific frequency band can be considerably reduced.

A distance of an antenna from the high impedances surface can be more reduced than a distance of an antenna positioned on a general electrical conductor. Thus, a space necessary for installing the antenna can be minimized. As a result, the high impedance surface structure can be efficiently applied to an internal antenna.

Moreover, the high impedance surface structure can affect a characteristic of the antenna. In other words, the antenna can be positioned on a high impedance surface so as to be an antenna having multi-band characteristics. Also, EMI caused by unnecessary electromagnetic waves on a circuit board or the like can be solved.

### DESCRIPTION OF DRAWINGS

The above and other features and advantages of the present invention will become more apparent by describing in detail exemplary embodiments thereof with reference to the attached drawings in which:

FIG. 1 illustrates a perspective view of a high impedance surface structure manufactured using a conventional artificial magnetic conductor (AMC);

FIG. 2A illustrates a plan view of a high impedance surface structure manufactured using an AMC, according to an embodiment of the present invention;

FIG. 2B illustrates a plan view of a part A constituting a unit cell of the high impedance surface structure illustrated in FIG. 2A, according to an embodiment of the present invention;

FIG. 3A illustrates a cross-sectional view taken along line I-I of the plan view of the part A of the high impedance surface structure illustrated in FIG. 2B, according to an embodiment of the present invention;

FIG. 3B illustrates a cross-sectional view of the high impedance surface structure illustrated in FIG. 3A to which an antenna is adhered, according to an embodiment of the present invention;

FIG. 4 is a graph illustrating a frequency bandwidth of the high impedance surface structure illustrated in FIG. 2A calculated with a computer simulation using a reflection phase;

FIGS. 5A through 5E illustrate plan views of different patterns of a unit cell of a high impedance surface structure according to embodiments of the present invention;

FIG. 6 is a view illustrating a configuration of an radio frequency identification (RFID) system including a tag antenna with the high impedance surface structure and with the lower structure different from a high impedance surface structure of the present invention, according to an embodiment of the present invention;

FIG. 7 is a view illustrating a system measuring a return loss of a lower structure of an antenna, according to an embodiment of the present invention;

FIG. 8 is a graph illustrating a return loss of a 900 MHz standard dipole antenna when the lower structure of the antenna illustrated in FIG. 7 is air layer or a conductor layer; and

FIG. 9 is a graph illustrating a return loss of a 900 MHz standard dipole antenna where the lower structure illustrated in FIG. 7 is a high impedance surface structure.

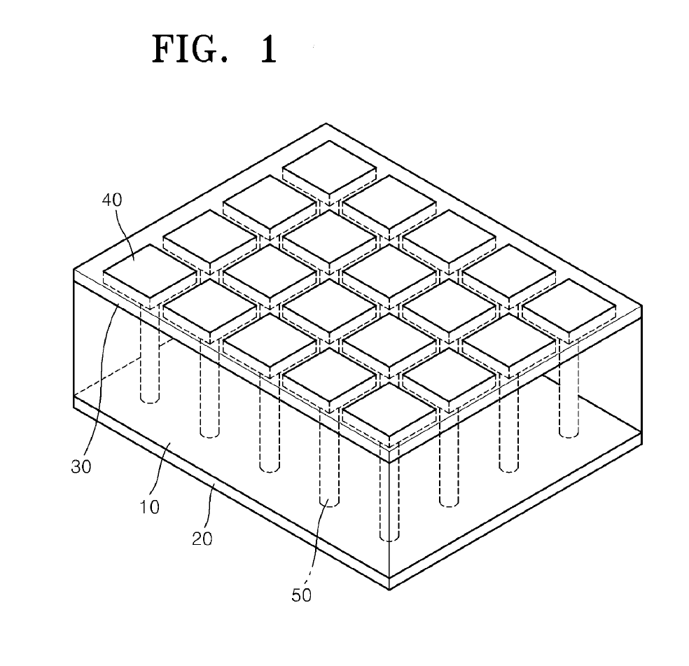

### BEST MODE

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thickness or size of the elements are omitted or exaggerated for clarity. Like reference numerals in the drawings denote like elements.

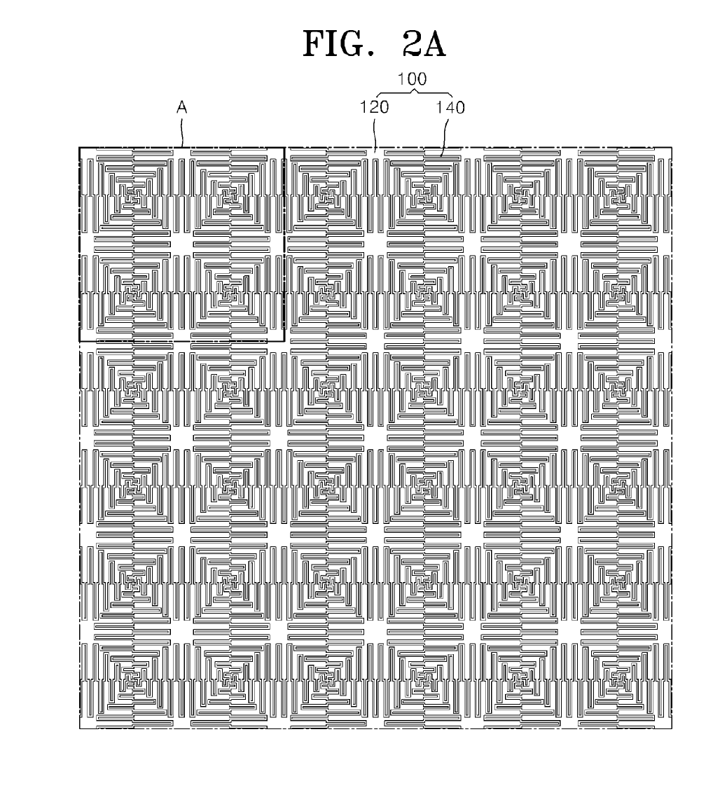

FIG. 2A illustrates a plan view of a high impedance surface structure manufactured using an artificial magnetic conductor (AMC), according to an embodiment of the present invention.
1. Referring to FIG. 2A, the high impedance surface structure according to the present embodiment includes a ground layer (not shown) formed of a first conductor layer and a high impedance surface (HIS) layer 100 including a first dielectric layer (not shown), second conductor layers 120, and second dielectric layers 140. Similar to a part A, the HIS layer 100 is formed of unit cells with repeated patterns each including the second conductor layers 120 and the second dielectric layers 140. The high impedance surface structure of the present embodiment may further include a third dielectric layer (not shown) formed on the HIS layer 100.

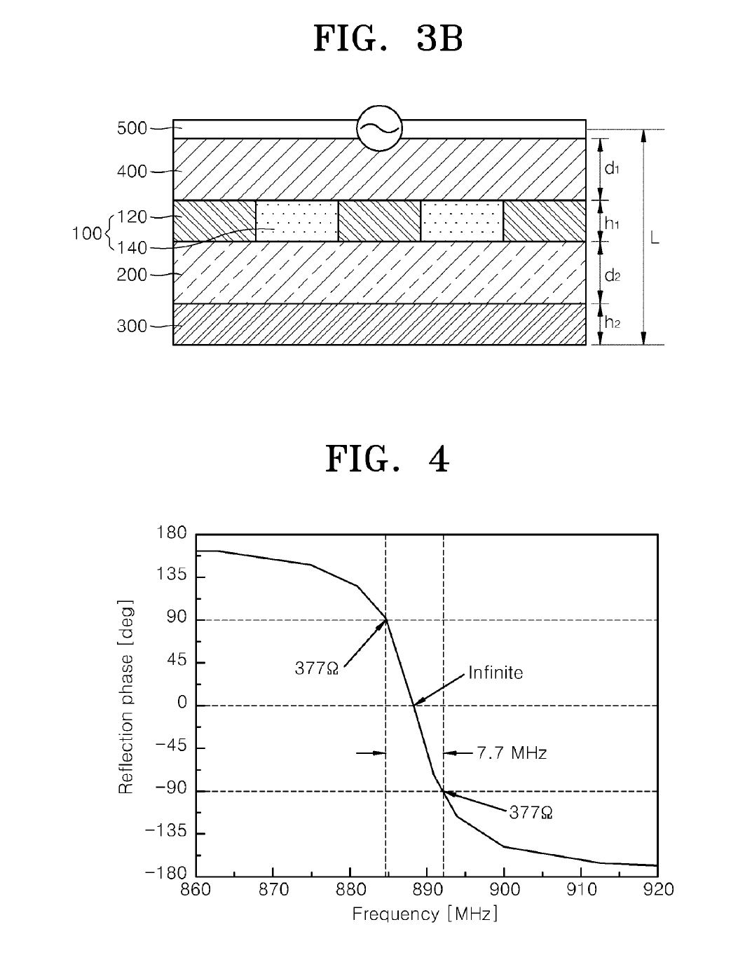

Vias connecting the second conductor layers 120 to the ground layer (not shown) are not formed under the HIS layer 100, the high impedance surface structure of the present embodiment can have a sufficient high impedance characteristic. This point will be described in detail with reference to FIG. 4. Although the vias are formed in the high impedance surface structure of the present embodiment as in the prior art, the high impedance surface structure may have high impedance characteristics. However, a frequency band of the high impedance surface structure may vary if the vias are formed. This variation may vary depending on the thicknesses, patterns, dielectric constants, and the like, of the components of the high impedance surface structure.

FIG. 2B illustrates a detailed plan view of the part A constituting one of the unit cells of the high impedance surface structure illustrated in FIG. 2A, according to an embodiment of the present invention.
1. Referring to FIG. 2B, in a unit cell of the high impedance surface structure of the present embodiment, the second conductor layers 120 are interdigitated with one another in the form of beat waves so that the second dielectric layers 140 are positioned between the second conductor layers 120. The formation of the interdigitated patterns can contribute to improving the capacitances of capacitors formed by the second conductor layers 120 and the second dielectric layers 140.

The interdigitated patterns will now be described in more detail in terms of the second dielectric layers 140. The unit cell is formed in a square shape of which a length of a side is c. The second dielectric layers 140 each have a pattern of which four strands are connected to one another in the form of a Chinese character [symbol] or ‘ [symbol] ’, which means man, positioned ¼ the distance from each vertex along a diagonal line. In other words, the second dielectric layers 140 each have a pattern spreading in the form of beat waves at a connection point of each Chinese character [symbol] or ‘ [symbol] ’

Two Chinese characters [symbol] are formed diagonal to each other where one connection point is on the left upper side and the other connection point is on the right lower side. One cycle of the beat waves of the second dielectric layers 140 is completed between the connection points of Chinese characters [symbol] , and half a cycle is formed at each side of the square shape so that a maximum amplitude of the beat waves is formed on each side of the square shape.

Such beat waves will now be described in terms of symmetry. The beat waves are symmetric with respect to the center between connection points of the Chinese characters [symbol] or ‘ [symbol] ’. Beat waves of half a cycle of four strands are dot symmetric at a connection point of each Chinese character [symbol] or ‘ [symbol] .’

As shown in FIG. 2B, a width of the second dielectric layers 140 is a, and a width of the interdigitated second conductor layers 120 is b. The unit cell includes a square part in which only the second conductor layers 120 exist, and a length of one side of the square part may be g. The above-mentioned parameters a, b, and g may be set according to a required bandwidth or the like, of an electromagnetic device to which the high impedance surface structure of the present embodiment is applied.

Beat waves are formed in a structure in which nine crests or troughs are formed between connection points of a Chinese character [symbol] or ‘ [symbol] .’ Each side is formed of a half cycle, i.e., 4.5 crests or troughs. To be accurate, if 9 crests are formed, 8 troughs are formed or vice versa. Thus, a crest or trough at a maximum height is formed in the center of the beat waves. As shown in FIG. 2B, such crests or troughs are formed by bending the second dielectric layers 140 having the width a and a straight line shape at a right angle. The second dielectric layers 140 are bent in a right angle twice in the same direction at the crests or troughs and twice in opposite directions at the intermediate portions of the crests or troughs. Thus, a portion forming a crest or trough has a pole formed of a pair of parallel second dielectric layers, and a central portion of the crest or trough has an inflection shape.

In the pattern of a HIS layer of the present embodiment, conductors in a unit cell are interdigitated with one another. Thus, an area of the unit cell required for obtaining a high impedance characteristic for a specific frequency band can be considerably reduced.

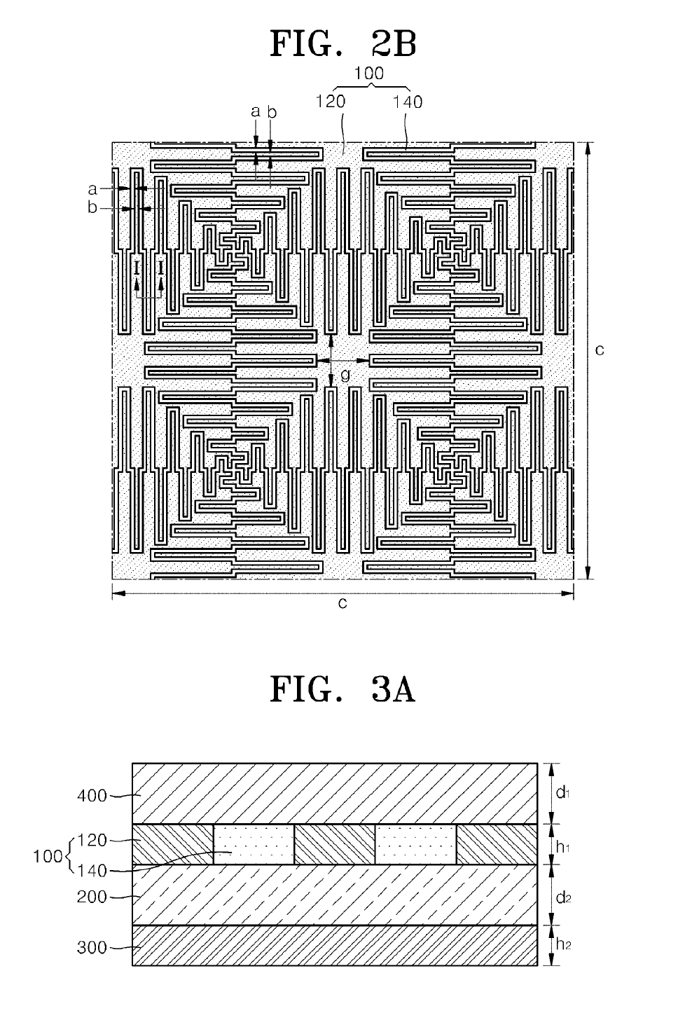

FIG. 3A illustrates a cross-sectional view taken along line I-I of the plan view of the part A of the high impedance surface structure illustrated in FIG. 2B, according to an embodiment of the present invention.
1. Referring to FIG. 3A, the high impedance surface structure includes a ground layer 300 formed of a first conductor layer, a first dielectric layer 200, the HIS layer 100 including the second conductor layers 120 and the second dielectric layers 140, and a third dielectric layer 400. In the present embodiment, the third dielectric layer 400 may be omitted.

The first, second, and third dielectric layers 200, 140, and 400 have relative dielectric constants of ∈_{γ3}, ∈_{γ2}, and ∈_{γ1}, respectively. The ground layer 300 has a thickness h₂, the first dielectric layer 200 has a thickness of d₂, the HIS layer 100 has a thickness h₁, and the third dielectric layer 400 has a thickness d₁. Such dielectric constants and thicknesses will be substituted with actual values during the measurement of a reflection phase and may be changed so as to appropriately form the high impedance surface structure.

The high impedance surface structure of the present embodiment does not require vias, and thus, is manufactured in a simple process. Also, the high impedance surface structure can be fully utilized so as to improve utilization efficiency of spaces of the conductor layers. Thus, a frequency band can be accurately and easily tuned.

FIG. 3B illustrates a cross-sectional view of the high impedance surface structure illustrated in FIG. 3A to which an antenna is adhered, according to an embodiment of the present invention.
1. Referring to FIG. 3B, an antenna 500 is adhered to an upper surface of the third dielectric layer 400 of the high impedance surface structure. In a case where an antenna is adhered to such a high impedance surface structure, a gap of ¼ or more of a resonance frequency wavelength required for installing an antenna on a conductor conventionally does not need to be manufactured.

In other words, in a case where an antenna is directly adhered to an electrical conductor, the current short-circuits. Thus, the efficiency and gain of the antenna is greatly reduced, and the antenna does not perform its own functions. In a case where the antenna is placed parallel to a surface of a conductor, the antenna must be kept at a distance of ¼ of a resonance frequency from the conductor. A relatively far distance of several cm is required for a general GHz frequency band, and thus the size of the antenna is increased.

However, in a case where the high impedance surface structure of the present invention is used, the whole thickness L of an antenna may considerably decrease. For example, the distance between the antenna and a conductor may be greatly reduced to a range of several millimeters. Thus, a space necessary for installing the antenna can be minimized, and the high impedance surface structure can be efficiently applied to an internal antenna or the like.

In a case where the antenna is used in the vicinity of a material having a high dielectric constant or loss, a resonance frequency of the antenna is distorted. Thus, the antenna does not resonate in a desired frequency band. A material such as a conventional absorber is used to solve to this problem. However, such an absorber is not required in a case where the high impedance surface structure of the present invention is used. In other words, if a method as described with reference to FIG. 3B is applied to the antenna, the resonance frequency of the antenna can be prevented from being distorted. Also, the gain of the antenna can be maintained constant at a predetermined magnitude or increased. Thus, the performance of the antenna can be maintained constant a predetermined level or increased.

FIG. 4 is a graph illustrating a frequency bandwidth of the high impedance surface structure measured with a computer simulation using a reflection phase when plane waves are incident on the high impedance surface structure illustrated in FIG. 2A.

Referring to FIG. 4, the parameters of the components of each unit cell constituting the high impedance surface structure are illustrated in Table 1 below. The width b of the second conductor layers 120 between the second dielectric layers 140 adjacent thereto is equal to a width a of the second dielectric layers 140, i.e., 0.4 mm.

TABLE 1

| Parameter | a | c | g | d₁ | d₂ | h₁ | h₂ | εᵣ₁ | εᵣ₂ | εᵣ₃ |
|---|---|---|---|---|---|---|---|---|---|---|
| Length(mm) | 0.4 | 43.2 | 5.2 | 1.0 | 1.0 | 0.0175 | 0.0175 | 4.5 | 1.0 | 4.5 |

Referring to FIG. 4, the high impedance surface structure according to the present embodiment has an almost infinite resistance value at which a reflection phase is almost constant for a certain frequency range which is less than a frequency of 890 MHz, which is hereinafter referred to as a resonance frequency. Also, the high impedance surface structure has a free space impedance (FSI) characteristic having a resistance value of about 377Ω at a first frequency and a second frequency, where the first frequency is less than the resonance frequency and the second frequency is greater than the resonance frequency. Here, an interval of the first and second frequencies is 7.7 MHz and bandwidth of the high impedance surface. That is, at the interval the high impedance surface has HIS characteristic. The reflection phase is almost 180° at a frequency much less or much more than the resonance frequency. The high impedance surface has conductor characteristic at the frequency of 180° reflection phase.

At least one of the parameters illustrated in Table 1, for example, the thickness and electrical characteristics of the second conductor layers 120 and the first, second, and third dielectric layers 200, 140, and 400 of a high impedance surface structure, the number of times that the second conductor layers 120 are interdigitated, the inter digitated lengths and gaps of the second conductor layers 120, and the width of the second conductor layers 120 may be changed accordingly to adjust the resonance frequency, the first and second frequencies, and the bandwidth of the high impedance surface structure of the present embodiment. In particular, in a case where the second dielectric layers 140 are bent in more turns, the capacitances of the capacitors formed of the second conductor layers 120 and the second dielectric layers 140 are increased, a whole frequency band shifts to the left, i.e., toward a direction along which a resonance frequency is lowered.

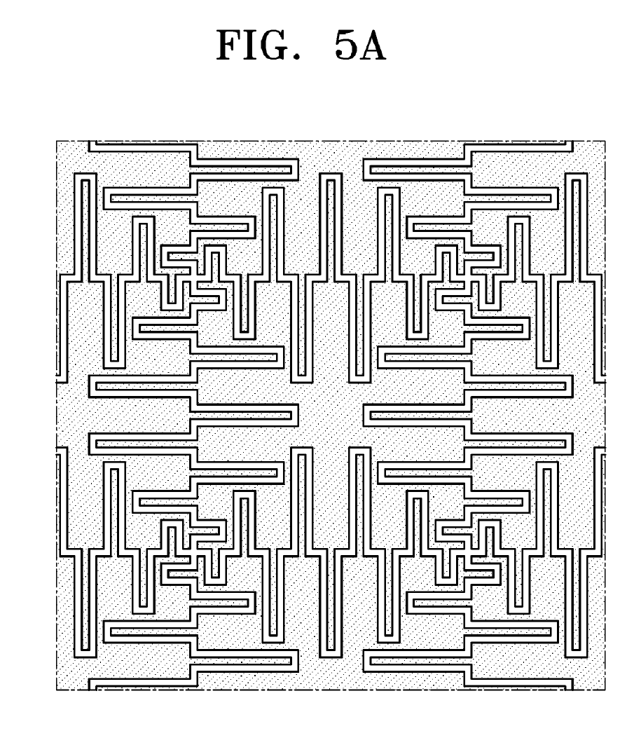

FIGS. 5A through 5E illustrate plan views of different patterns of each unit cell of a high impedance surface structure according to embodiments of the present invention.

Referring to FIGS. 5A through 5C, the numbers of crests or troughs of beat waves between connection points of Chinese characters [symbol] ‘ [symbol] ’ differs from the previous embodiment. In other words, five crests or troughs are formed for a cycle in FIG. 5A, seven crests or troughs are formed for a cycle in FIG. 5B. In FIG. 5C, five crests or troughs are formed as in FIG. 5A. However, a crest or trough at a central portion of the beat waves has a greater amplitude than the adjacent crests or troughs. Thus, a square part in which only second conductor layers 120 exist does not exist in a central part of a unit cell of FIG. 5C. The interdigitated structure of the second conductor layers 120, the symmetric structure of the second dielectric layers 140, and the like, are as described as in the previous embodiment. Also, the width a of the second dielectric layers 140 and the width b of the second conductor layers 120 may be changed to realize a high impedance surface structure having an appropriate frequency band.

Five or seven crests or troughs exist within beat waves of a cycle as illustrated in FIGS. 5A through 5C. However, the pattern of the second dielectric layers 140 may be formed so that three or less or nine or more crests or troughs exist.

Referring to FIGS. 5D and 5E, as in the previous embodiment, four strands of the second dielectric layers 140 are connected to one another in the form of a Chinese character [symbol] or ‘ [symbol] ’ and patterns are dot symmetric at a connection point. However, the second conductor layers 120 are not interdigitated, and the second dielectric layers 140 are not formed in the form of beat waves.

However, beat waves are formed, and the second conductor layers 120 are interdigitated in terms of the whole structures in FIGS. 5D and 5E. In other words, components forming crests or troughs of beat waves are not double parallel straight lines but double straight lines having one or more uneven patterns in the intermediate. Thus, the components form the beat waves, and second conductor layers 120 are interdigitated through the crests or troughs.

From this point of view, five crests or troughs are formed in FIG. 5D, and seven crests or troughs are formed in FIG. 5E. Alternatively, three or less or nine or more crests or troughs may be formed.

Uneven patterns are formed in intermediate parts in which crests or troughs are formed as illustrated in FIGS. 5D and 5E so as to improve utilization efficiency of a space for conductor layers. Thus, the capacitances of the capacitors formed of the second conductor layers 120 and the second dielectric layers 140 can be further increased.

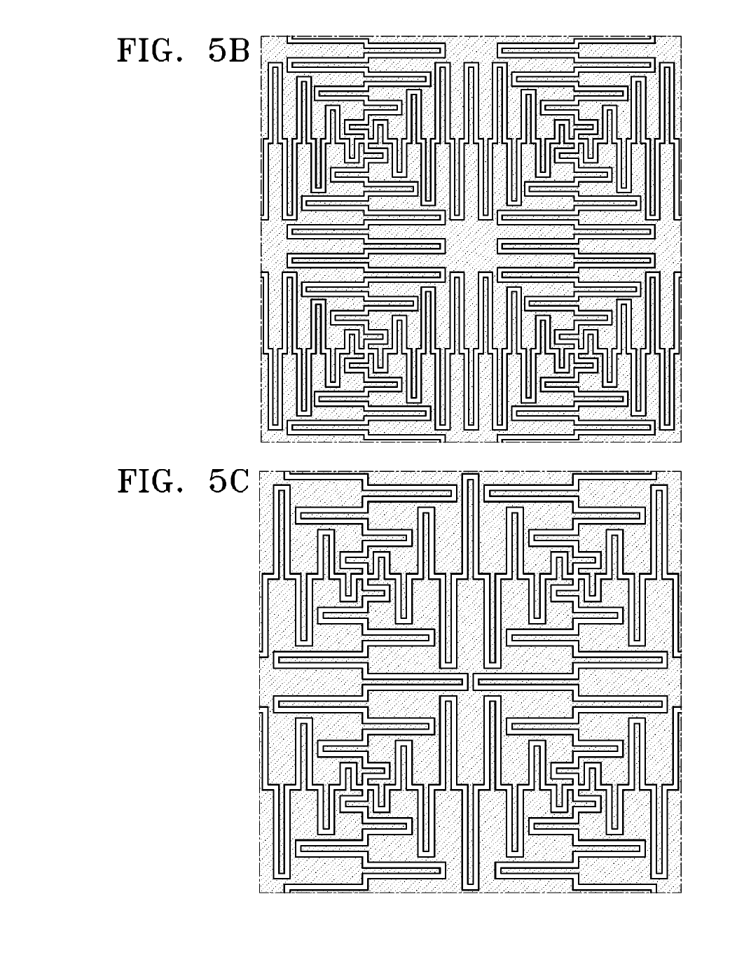

Interdigitated lengths of the conductor layers may be increased or decreased using the methods as described with reference to FIGS. 5A through 5E so as to infinitely form similar unit cell structures. Thus, a frequency band of a high impedance surface structure can be accurately and easily tuned.
1. FIG. 6 is a view illustrating a configuration of a radio frequency identification (RFID) system including a tag antenna with the high impedance surface structure and a lower structure different from the high impedance surface structure of the present invention, according to an embodiment of the present invention. Referring to FIG. 6, the RFID system includes an RFID reader antenna 1100, a tag antenna 1200, and an antenna lower structure 1300.

The lower structure of an antenna 1300 is formed of two layers, i.e., an α layer and a β layer that may be formed of one of three kinds of materials. In the first case, the α layer may be a glass epoxy (FR4) flat board, and the β layer may be an air layer. In the second case, the α layer may be the FR4 flat board, and the β layer may be an electrical conductor. In the third case, the α layer may be the high impedance surface structure of the previous embodiment, and the β layer may be the electrical conductor.

Table 2 below illustrates the parameters of the components of each unit cell applied to the high impedance surface structure in the third case. Table 3 below illustrates data values of measured maximum read distances of a tag antenna of an RFID system using a 900 MHz frequency band. In the present embodiment, the width b of the second conductor layers 120 is equal to the width a of the second dielectric layers 140, and the FR4 flat board has an approximate dielectric constant of 4.5 and a thickness of about 1 mm.

TABLE 2

| Parameter | a | c | g | d₁ | d₂ | h₁ | h₂ | εᵣ₁ | εᵣ₂ | εᵣ₃ |
|---|---|---|---|---|---|---|---|---|---|---|
| Length | 0.42 | 45.36 | 5.46 | 1.0 | 1.0 | 0.0175 | 0.0175 | 4.5 | 1.0 | 4.5 |
| (mm) | | | | | | | | | | |

TABLE 3

| Surface to which Tag | Maximum | Used Frequency |
|---|---|---|
| Antenna is Adhered | Read Distance | Band |
| 1) FR4 Flat Board in the Air¹⁾ | 450 cm | 910~914 MHz |
| 2) FR4 Flat Board on Conductor | 50 cm | |
| 3) High Impedance Surface On | 360 cm | |
| Conductor | | |

Referring to Table 3, a maximum read distance of a tag antenna of an RFID system that is almost equal to that of a lower structure of an antenna using an FR4 flat board in the air can be realized using the high impedance surface structure of the previous embodiment of the present invention. In the present embodiment, the maximum read distance of the high impedance surface structure is 360 cm. The parameters of the components constituting the high impedance surface structure may be changed to realize a maximum read distance that is more distant than that of the FR4 flat board in the air.

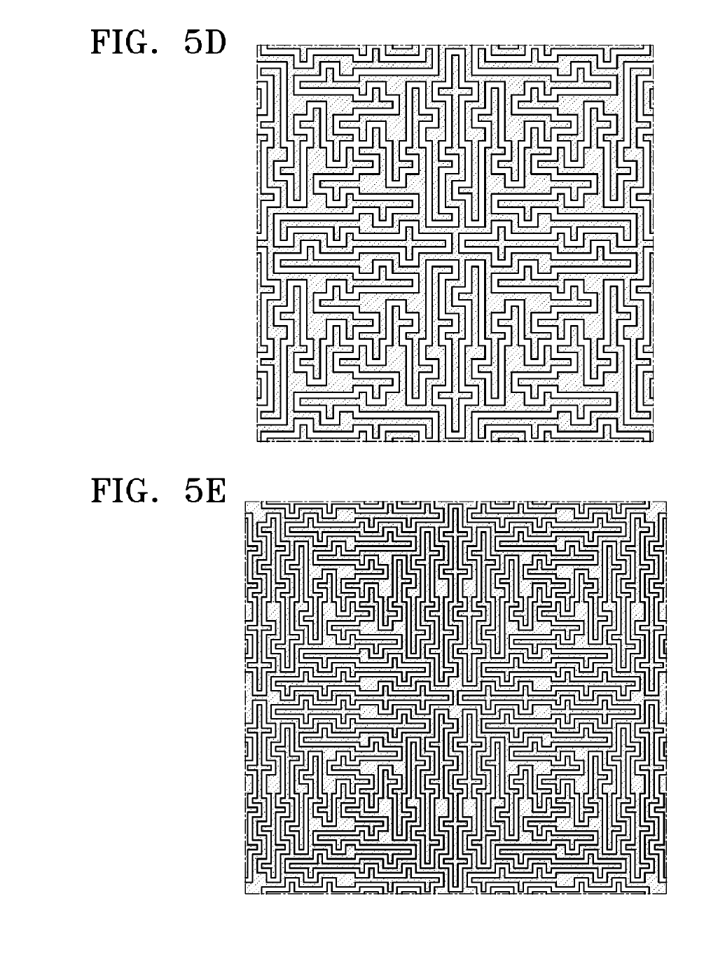

FIG. 7 is a view illustrating a system measuring a return loss of a lower structure of an antenna 1500, according to an embodiment of the present invention.
1. Referring to FIG. 7, the system includes a half-wavelength dipole antenna 1400 resonating at 900 MHz, the lower structure of an antenna 1500, and a vector network analyzer 1600 measuring a return loss. The vector network analyzer 1600 is connected to the half-wavelength dipole antenna 1400 through a coaxial cable 1700.

The lower structure of an antenna 1500 includes an FR4 flat board and a γ

layer that may be an air layer, a conductor layer, or the high impedance surface structure of the present embodiment. Table 4 below illustrates the parameters of the components of each unit cell of the high impedance surface structure of the previous embodiment. Here, the width b of the second conductor layers 120 is equal to the width a of the second dielectric layers 140, and the FR4 flat board has an approximate dielectric constant of 4.5 and a thickness of about 1 mm.

TABLE 4

| Parameter | a | c | g | d₁ | d₂ | h₁ | h₂ | εᵣ₁ | εᵣ₂ | εᵣ₃ |
|---|---|---|---|---|---|---|---|---|---|---|
| First | 0.36 | 38.88 | 4.68 | 1.0 | 1.0 | 0.0175 | 0.0175 | 4.5 | 1.0 | 4.5 |
| Length | | | | | | | | | | |
| (mm) | | | | | | | | | | |
| Second | 0.38 | 41.04 | 4.94 | 1.0 | 1.0 | 0.0175 | 0.0175 | 4.5 | 1.0 | 4.5 |
| Length | | | | | | | | | | |
| (mm) | | | | | | | | | | |

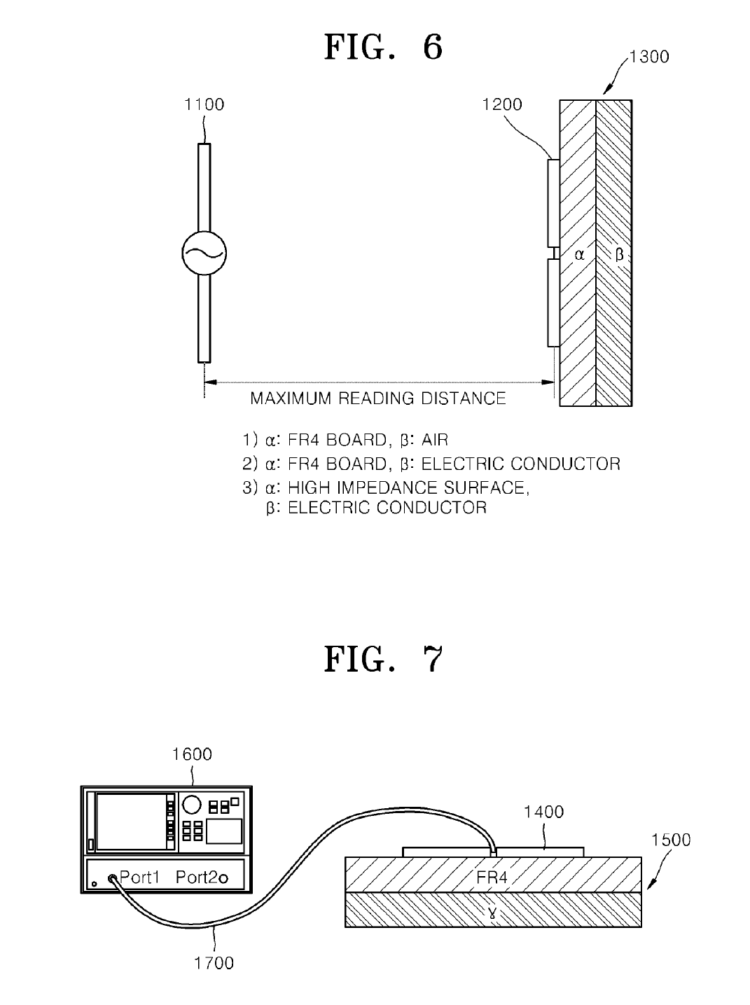

FIG. 8 is a graph illustrating a return loss of a 900 MHz standard dipole antenna when the lower structure of an antenna 1500 illustrated in FIG. 7 is an air layer or a conductor layer.
1. Referring to FIG. 8, the half-wavelength dipole antenna 1400 resonating at 900 MHz in free space is adhered on a conductor layer, and thus the performance of the half-wavelength dipole antenna 1400 is greatly deteriorated so that a frequency band cannot be distinguished.

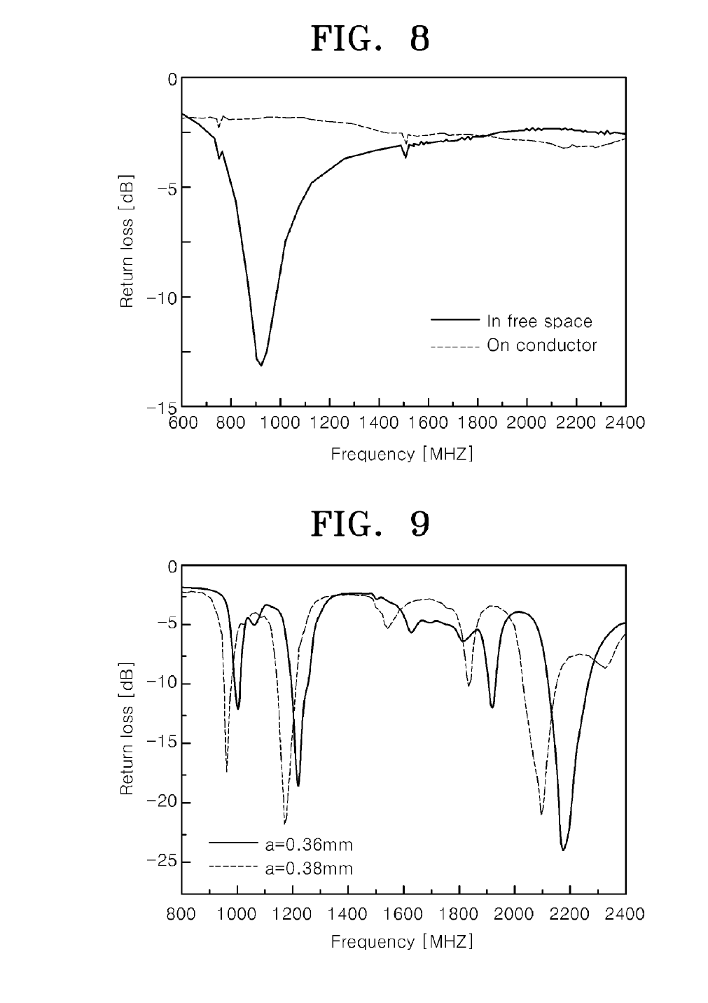

FIG. 9 is a graph illustrating a return loss of a 900 MHz standard dipole antenna when the lower structure of an antenna 1500 illustrated in FIG. 7 is a high impedance surface structure.
1. Here, the straight line denotes a first length (=0.36 mm) of the parameter a illustrated in Table 4, and the dotted line denotes a second length (=0.38 mm) of the parameter a illustrated in Table 4.

Referring to FIG. 9, in a case where the high impedance surface structure of the present embodiment is a lower structure of an antenna, an antenna illustrates a relatively good frequency band characteristic. In other words, resonance frequencies having low return losses appear in frequency bands of 900 MHz, between 1100 MHz and 1250 MHz, and between 2000 MHz and 2300 MHz.

A dipole antenna in a 900 MHz frequency band in free space is changed into an antenna having a multi-band. If a high impedance surface structure is used as a lower structure of structure of an antenna as described above, an antenna having a multi-band may be manufactured.

Frequencies of around 900 MHz and 1200 MHz are fundamental resonance frequencies, and frequencies of around 2000 MHz and 2200 MHz correspond to second harmonic resonance frequencies. Only the second harmonic resonance frequencies are illustrated in the graph of FIG. 9. However, a higher harmonic resonance frequency may occur and be a frequency band of the antenna.

A usable frequency band of an antenna using a high impedance surface structure does not depend on the size and shape of the antenna but on a characteristic of the high impedance surface structure. Thus, the high impedance surface structure may be formed according to the shape of an electromagnetic field formed through the structure of the antenna without a variation in a frequency band. For example, a high impedance surface structure may be formed in a long shape similar to the shape of a dipole antenna. Thus, the whole size of the dipole antenna can be considerably reduced.

It has been described that a high impedance surface structure of the present invention is applied to an antenna. However, the high impedance surface structure may be applied to electromagnetic devices requiring high impedance characteristics, i.e., the characteristic of a magnetic conductor in which a current cannot flow in a HIS layer in a specific frequency.

For example, a surface current flowing on a surface may not flow in a high impedance frequency band. Thus, the high impedance surface structure can be efficiently used on a circuit board of an electromagnetic device to prevent an electromagnetic inference (EMI) caused by unnecessary electromagnetic waves.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

The present invention relates to a high impedance surface structure used in an electromagnetic device, and more particularly, to a high impedance surface structure using an artificial magnetic conductor (AMC). The high impedance surface structure using an AMC according to the present invention does not require vias between conductor layers of a high impedance surface structure and a ground layer. Thus, a process of manufacturing the vias can be omitted, and manufacturing costs due to the vias can be reduced. Also, utilization efficiency of a space for conductors of the high impedance surface structure can be increased, and a frequency band can be accurately and easily tuned since the high impedance surface structure is fully utilized.

1. A high impedance surface structure using AMC (an artificial magnetic conductor), comprising:
a ground layer formed of a first conductor layer;
a first dielectric layer formed on the ground layer; and
an HIS (high impedance surface) layer formed of second conductor layers and a second dielectric layer on the first dielectric layer, wherein the second conductor layers are interdigitated with one another, so that the second dielectric layer is positioned between the second conductor layers,
wherein vias connecting the second conductor layers to the ground layer are not formed.

2. The high impedance surface structure of claim 1, further comprising a third dielectric layer on the HIS layer.

3. The high impedance surface structure of claim 1, wherein the high impedance surface structure is used in an antenna.

4. The high impedance surface structure of claim 3, wherein the antenna is adhered to one of the HIS layer and the third dielectric layer formed on the HIS layer of the high impedance surface structure.

5. The high impedance surface structure of claim 4, wherein a distance between the antenna and the HIS layer is ¼ or less of a wavelength of received electromagnetic waves.

6. The high impedance surface structure of claim 1, wherein the high impedance surface structure has a high impedance characteristic in which a reflection phase is constant for a specific frequency and an FSI (free space impedance) characteristic in which the reflection phase is 90° with respect to one of a first and second frequency, which are respectively lower and higher frequencies than the specific frequency.

7. The high impedance surface structure of claim 6, wherein the high impedance surface structure has the high impedance characteristics in which a reflection phase is constant for high order harmonic frequencies of the specific frequency and the FSI characteristics for high order first and second frequencies of the high harmonic frequencies.

8. The high impedance surface structure of claim 7, wherein a distance between the first and second frequencies is a frequency bandwidth or a high impedance characteristic of the high impedance surface structure.

9. The high impedance surface structure of claim 7, wherein the high impedance surface structure is adhered to an antenna so as to use the antenna as an antenna having a multi-band.

10. The high impedance surface structure of claim 6, wherein the specific frequency and the first and second frequencies are tuned by using at least one of the thicknesses and electrical characteristics of the second conductor layers and the first and second dielectric layers of the HIS layer, the number of times the second conductor layers are interdigitated, the interdigitated lengths and gaps of the second conductor layers, and the width of the second conductor layers.

11. The high impedance surface structure of claim 1, wherein the HIS layer comprises a plurality of unit cells having identical patterns formed of the second conductor layers and the second dielectric layers.

12. The high impedance surface structure of claim 11, wherein the unit cells have square horizontal cross-sections and patterns in which four strands of the second dielectric layers are connected to one another in the form of a Chinese character [symbol] or ‘ [symbol] ’ positioned ¼ the distance from each vertex along a diagonal line.

13. The high impedance surface structure of claim 12, wherein:
two Chinese characters [symbol] are formed along a first diagonal line from each vertex of each of the unit cells, and two Chinese characters ‘ [symbol] ’ are formed within a second diagonal line from each vertex of each of the unit cells; and
components of the second dielectric layers spread vertically and to the horizontally in the form of beat waves between the connection points of the Chinese characters [symbol] or ‘ [symbol] ,’
wherein the beat waves have a largest amplitude on four sides of the square and complete one cycle between the connection points of the Chinese characters [symbol] or ‘ [symbol] ’, patterns of the components of the second dielectric layers are formed in the dot symmetric form based on the connection points, and the beat waves comprise at least three crests and troughs for one cycle between the connection points.

14. The high impedance surface structure of claim 13, wherein the components of the second dielectric layers having a width less than a predetermined length are bent twice in a right angle in an identical direction at the crests or troughs so that a part forming the crests or troughs comprises a pole formed of a pair of parallel second dielectric layers and bent twice in different directions at intermediate parts of the crests or troughs.

15. The high impedance surface structure of claim 13, wherein the components of the second dielectric layers having a width less than a predetermined length are bent in right angles so that at least one uneven part is formed at intermediate parts of the crests or troughs, bent twice in an identical direction at the crests, troughs, or the uneven parts, and bent twice in different directions at the intermediate parts of the crests and the troughs.

16. A high impedance surface structure using an AMC, comprising:
a ground layer formed of a first conductor layer;
a first dielectric layer formed on the ground layer; and
an HIS layer formed of second conductor layers and a second dielectric layer on the first dielectric layer, wherein the second conductor layers are interdigitated with one another so that the second dielectric layer is positioned between the second conductor layers,
the HIS layer comprises unit cells having square horizontal cross-sections and identical patterns in which four strands of the second dielectric layers are connected to one another in the form of a Chinese character [symbol] or ‘ [symbol] ’ positioned ¼ the distance from each vertex along a diagonal line,
two Chinese characters [symbol] are formed within a first diagonal line from each vertex of each of the unit cells, and two Chinese characters ‘ [symbol] ’ are formed within a second diagonal line from each vertex of each of the unit cells,
components of the second dielectric layers spread vertically and horizontally in the form of beat waves at connection points of the Chinese characters [symbol] or ‘ [symbol] ’, and the beat waves have a largest amplitude on four sides of the square and complete one cycle at the connection points of the Chinese characters [symbol] or ‘ [symbol] ,’
patterns of the components of the second dielectric layers are formed in the dot symmetric form based on the connection points,
the components of the second dielectric layer having a width less than a predetermined length are bent at a right angle so that the beat waves comprise at least three crests or troughs for one cycle between the connection points, and vias are formed between the second conductor layers and the ground layer to realize a characteristic of the AMC.

17. The high impedance surface structure of claim 16, wherein the components of the second dielectric layer are bent twice in an identical direction at the crests or troughs and bent twice in different directions at intermediate parts of the crests or troughs.

18. The high impedance surface structure of claim 16, wherein the crests or troughs of the beat waves are formed of a double second dielectric layer and comprise at least one uneven part at the intermediate parts of the crests or troughs, and the components of the second dielectric layer are bent twice in an identical direction at the crests, the troughs, or the uneven part and bent twice in different directions at the intermediate parts between the crests and troughs.

19. The high impedance surface structure of claim 16, wherein the high impedance surface structure is used on a circuit board to prevent an EMI (electromagnetic interference) caused by electromagnetic waves generated on the circuit board.

20. An antenna device using a high impedance surface structure, comprising:
the high impedance surface structure of claim 1; and
an antenna adhered on an upper surface of the high impedance surface structure.

21. The antenna device of claim 20, wherein the antenna is adhered to one of an HIS layer and a third dielectric layer formed on the HIS layer of the high impedance surface structure.

22. The antenna device of claim 21, wherein the high impedance surface structure is adhered to the antenna to be parallel with the antenna, and a distance between the antenna and the HIS layer is ¼ or less of a wavelength of received electric waves.

23. The antenna device of claim 20, wherein the antenna is a tag antenna of an RFID (radio frequency identification) system.

24. The antenna device of claim 20, wherein a frequency band of the antenna is determined by the high impedance surface structure.

25. The antenna of claim 20, wherein the high impedance surface structure has a high impedance characteristic in which a reflection phase is constant with respect to a specific frequency and an FSI characteristic in which the reflection phase is 90° changed with respect to one of first and second frequencies respectively lower and higher than the specific frequency, and the high impedance surface structure is adhered to the antenna so as to use the antenna as an antenna having a multi-band.

26. An electromagnetic device manufactured using the high impedance surface structure of claim 1.

27. The electromagnetic device of claim 26, wherein the electromagnetic device is an electromagnetic device requiring a high impedance characteristic.

28. The electromagnetic device of claim 27, wherein the high impedance characteristic is a characteristic of a magnetic conductor in which a current is not able to flow on the HIS layer in a specific frequency.
